(19) United States
(12) Patent Application Publication
(10) Pub. No.: US 2025/0311034 A1
(43) Pub. Date: Oct. 2, 2025

(54) RELAY COMMUNICATION METHOD, DEVICE, AND STORAGE MEDIUM

(71) Applicant: BEIJING XIAOMI MOBILE SOFTWARE CO., LTD., Beijing (CN)

(72) Inventors: Yang SHEN, Beijing (CN); Xinli WANG, Beijing (CN)

(73) Assignee: BEIJING XIAOMI MOBILE SOFTWARE CO., LTD., Beijing (CN)

(21) Appl. No.: 18/864,356

(22) PCT Filed: May 10, 2022
(86) PCT No.: PCT/CN2022/092064

§ 371 Date: Nov. 8, 2024

(51) Int. Cl. H04W 76/15; H04W 8/22; H04W 76/19; H04W 88/04

(52) U.S. Cl. CPC H04W 76/15; H04W 8/22; H04W 76/19; H04W 88/04

(57) ABSTRACT

A relay communication method, a device, and a storage medium are provided. The method includes: in response to receiving relay service requests sent by a plurality of remote terminals, performing a Quality of Service (QoS) capability detection on a relay terminal; and on the basis of a capability detection result, performing a relay access to the network for the plurality of remote terminals.

### CROSS REFERENCE TO RELATED APPLICATIONS

The present disclosure is the U.S. national phase application of International Application No. PCT/CN2022/092064 filed on May 10, 2022, the content of which is incorporated herein by reference in its entirety for all purposes.

### TECHNICAL FIELD

The present disclosure relates to the field of communication technology, in particular, to a relay communication method, a device, and a storage medium.

### BACKGROUND

Proximity based Services (ProSe) user equipment-to-network relay (UE-to-Network Relay) can provide the relay functionality to support the connection to the network for ProSe remote UE in the 5th Generation Wireless Communication System (5G). The ProSe UE-to-Network Relay can be used for both public safety services and commercial services (e.g., including interactive services). The UE-to-Network Relay is also known as relay UE.

The ProSe UE-to-Network Relay can support the following functions to enable the connection to the network. For example, the 5G ProSe UE-to-Network Relay Discovery service defined in the current specification can allow the ProSe UE-to-Network Relay to be discovered by 5G ProSe remote UE, and to access the 5G system as UE. Between the 5G ProSe remote UE and the network, the relay access is supported, as well as the relay unicast traffic (such as uplink and downlink) based on Internet Protocol (IP), Ethernet or unstructured service types.

### SUMMARY

According to a first aspect of the present disclosure, a relay communication method is provided. The method is performed by a relay terminal. The method can include: performing, in response to receiving relay service requests sent by multiple remote terminals, a Quality of Service (QoS) capability detection on the relay terminal; and performing, based on a capability detection result, a relay access to the network for the multiple remote terminals.

According to a second aspect of the present disclosure, a relay communication method is provided. The method is performed by a remote terminal. The method can include: receiving limited resource indication information sent by a relay terminal, wherein the limited resource indication information is sent by the relay terminal in response to a Quality of Service (QoS) capability detection result indicating that a QoS capability is not sufficient to provide relay services for multiple remote terminals simultaneously; and adjusting, based on the limited resource indication information, a relay access network policy.

According to a third aspect of the present disclosure, a relay communication device is provided. The device includes: a processor; and a memory configured to store instructions executable by the processor. The processor is configured to implement the method described in the first aspect or any of the embodiments of the first aspect.

According to a fourth aspect of the present disclosure, a relay communication device is provided. The device includes: a processor; and a memory configured to store instructions executable by the processor. The processor is configured to implement the method described in the second aspect or any of the embodiments of the second aspect.

According to a fifth aspect of the present disclosure, a non-transitory computer-readable storage medium is provided. When instructions in the storage medium are executed by a processor of a relay terminal, the relay terminal is caused to implement the method described in the first aspect or any of the embodiments of the first aspect.

According to a sixth aspect of the present disclosure, a non-transitory computer-readable storage medium is provided. When instructions in the storage medium are executed by a processor of a remote terminal, the remote terminal is caused to implement the method described in the second aspect or any of the embodiments of the second aspect.

It should be understood that the general description in the above and the detailed description in the following are only exemplary and explanatory, and cannot limit the present disclosure.

### BRIEF DESCRIPTION OF THE DRAWINGS

The drawings, which are incorporated in and constitute a part of this specification, illustrate embodiments consistent with the present disclosure and serve together with the specification to explain principles of the present disclosure.

FIG. 1 is a schematic diagram of a relay communication scene according to one or more embodiments of the present disclosure.

FIG. 2 is a schematic diagram of an end-to-end QoS configuration according to one or more embodiments of the present disclosure.

FIG. 3 is a flowchart of a relay communication method according to one or more embodiments of the present disclosure.

FIG. 4 is a flowchart of a relay communication method according to one or more embodiments of the present disclosure.

FIG. 5 is a flowchart of a relay communication method according to one or more embodiments of the present disclosure.

FIG. 6 is a flowchart of a relay communication method according to one or more embodiments of the present disclosure.

FIG. 7 is a flowchart of a relay communication method according to one or more embodiments of the present disclosure.

FIG. 8 is a schematic diagram of a relay communication signaling process according to one or more embodiments of the present disclosure.

FIG. 9 is a schematic diagram of a relay communication signaling process according to one or more embodiments of the present disclosure.

FIG. 10 is a schematic diagram of a relay communication apparatus according to one or more embodiments of the present disclosure.

FIG. 11 is a schematic diagram of a relay communication apparatus according to one or more embodiments of the present disclosure.

FIG. 12 is a schematic diagram of a relay communication device according to one or more embodiments of the present disclosure.

### DETAILED DESCRIPTION

Embodiments of the present disclosure will be described in detail here, with examples shown in the drawings. When referring to the drawings, unless otherwise indicated, the same numbers in different drawings represent the same or similar elements. The embodiments described in the following do not represent all embodiments consistent with the present disclosure.

The methods provided by the present disclosure can be applied to the relay communication scene shown in FIG. 1. The relay communication scene includes a remote terminal (i.e. 5G ProSe remote UE, or referred to as ProSe remote UE, remote UE, UE at the remote end, etc.), relay UE, a base station, a core network, and a data network. In some embodiments, the base station can be the next Generation Radio Access Network (NG-RAN), the core network can be the 5G core network (5G Core, or 5GC), and the NG-RAN and the 5GC can be collectively referred to as 5GS.

As shown in FIG. 1, the relay UE can use the Uu interface to relay with the NG-RAN for information exchange, and can use the PC5 interface to relay with the remote UE for information exchange. For 5GS including NG-RAN and 5GC, the N6 interface can be used to achieve data communication with the data network.

It can be understood that the relay communication scene shown in FIG. 1 is only for illustrative purpose. The relay communication system can also include other network devices or terminals, such as the wireless backhaul device, which are not shown in FIG. 1. Embodiments of the present disclosure do not limit the number of devices and terminals included in the relay communication scene.

It can be further understood that the relay communication scene shown in embodiments of the present disclosure includes a network that provides wireless communication functionality. The network that provides the wireless communication functionality can be implemented using different communication technologies, such as Code Division Multiple Access (CDMA), Wideband Code Division Multiple Access (WCDMA), Time Division Multiple Access (TDMA), Frequency Division Multiple Access (FDMA), Orthogonal Frequency Division Multiple Access (OFDMA), Single Carrier FDMA (SC-FDMA), and Carrier Sense Multiple Access with Collision Avoidance. According to various factors such as the capacity, the rate, and the latency of different networks, the networks can be divided into 2nd Generation (2G) networks, 3G networks, 4G networks, or future evolved networks, for example, 5G networks. The 5G network can also be referred to as the New Radio (NR) network. For ease of description, the wireless communication network in embodiments of the present disclosure are referred to as network for short.

In some embodiments, the base station involved in the present disclosure can also be referred to as a wireless access network device. The wireless access network device can be an evolved node B (eNB), a home base station, an access point (AP), a wireless backhaul node, or a transmission point (TP), etc. in a wireless fidelity (WIFI) system. The wireless access network device can also be a gNB in the NR system, or a component or some devices that constitute the base station. When it refers to a Vehicle to Everything (V2X) communication system, the network device can also be a vehicle mounted device. It should be understood that the specific technology and the specific device form adopted by the network device are not limited in embodiments of the present disclosure.

In some embodiments, the remote terminal or the relay terminal involved in the present disclosure, which can also be referred to a terminal device, a mobile station (MS), a mobile terminal (MT), etc., is a device that provides voice and/or data connectivity to users. For example, the terminal can be a handheld device, a vehicle mounted device, etc. with wireless connectivity. In some embodiments, some examples of the terminal include mobile phones, pocket personal computers (PPC), handheld computers, personal digital assistants (PDA), laptops, tablets, wearable devices, or onboard devices, etc. In some embodiments, when it refers to a Vehicle to Everything (V2X) communication system, the terminal device can also be a vehicle mounted device. It should be understood that the specific technology and the specific device form adopted by the terminal are not limited in embodiments of the present disclosure.

In some embodiments, the relay terminal involved in the present disclosure should be a terminal device that can achieve the relay functionality.

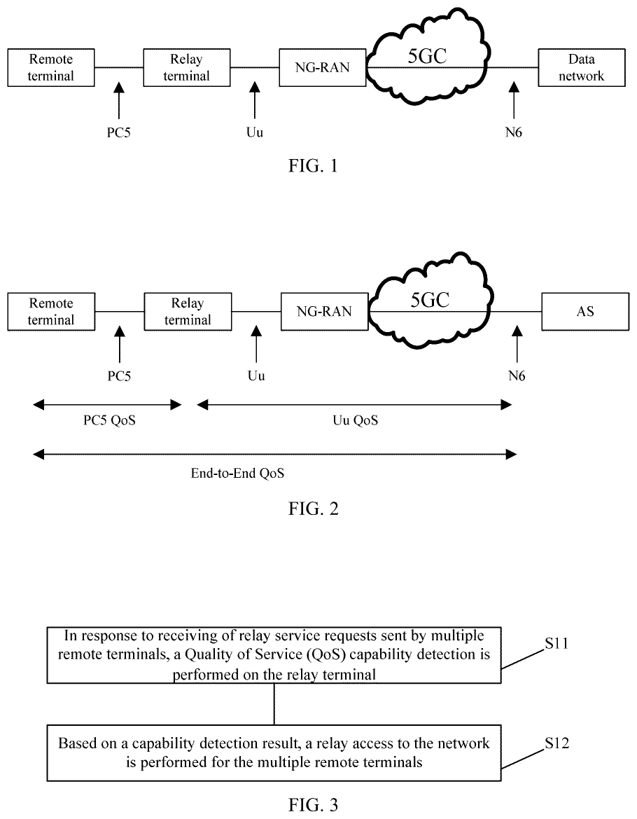

As shown in FIG. 1, when the remote UE needs to establish a communication connection with the User Plane Function (UPF), the relay UE can be used for providing the relay functionality for the remote UE. When it is in the relaying, the Quality of Service (QoS) requirements of the relay traffic between the remote UE and the UPF, i.e. the end-to-end QoS can be satisfied through corresponding QoS control for the PC5 interface between the remote UE and the relay UE (such as PC5 QoS control), and the QoS control for the packet data unit (PDU) session established between the relay UE and the UPF (i.e. Uu QoS control). As shown in FIG. 2, in some embodiments, the PC5 QoS can be controlled using PC5 QoS rules and PC5 QoS parameters, as specified in clause 5.4 of the Technical Specification (TS) 23.287. In some embodiments, the PC5 QoS parameters can include a PC5 QoS indicator (PQI), a guaranteed flow bit rate (GFBR), a maximum flow bit rate (MFBR), a PC5 link aggregated maximum bit rate (PC5 LINK-AMBR), a range, etc. In some embodiments, the QoS for the PDU session established between the relay UE and the UPF (i.e. Uu QoS) can be controlled using QoS rules and 5G QoS parameters, as specified in clause 5.7 of TS 23.501. In some embodiments, the 5G QoS parameters can include, for example, a 5G QoS indicator (5QI), the GFBR, the MFBR, etc.

It can be understood that the end-to-end QoS can be satisfied only when the QoS requirements are appropriately translated and are satisfied on both PC5 QoS and Uu QoS legs.

In the related art, the QoS mapping can be pre-configured or provided to the relay UE by the Policy Control Function (PCF) using the ProSe Policy, as specified in clause 5.1.4.1 of TS 23.304. The QoS mapping can include one or more mapping entries, for example, mapping entries in 5QI and PQI.

For QoS flows initiated and established by the network, the Session Management Function (SMF) on the network side can generate QoS rules, QoS flow level QoS parameters (such as 5QI, GFBR, MFBR, etc.), and signals to the relay UE using the PDU Session Establishment/Modification procedure, based on Policy and Charging Control (PCC) rules or local configurations thereof.

For the PDU session used for the relay access, the SMF always provides the QoS flow level QoS parameters to the relay UE when the QoS flow is established. The relay UE then determines the PQI based on QoS mapping, and determines the PC5 QoS parameters for corresponding PC5 QoS flow based on the determined PQI. The GFBR and MFBR values for the PC5 guaranteed bit rate (GBR) QoS flow are set equal to the GFBR and MFBR values for the GBR QoS flow, respectively.

For the PC5 QoS flows initiated by the remote UE, the remote UE can provide QoS information (Info) to the relay UE to achieve establishment or modification of the PC5 QoS flows. The PC5 QoS parameters contained in the QoS information (Info) received by the relay UE can be interpreted as the QoS requirements the relay UE needs to meet, i.e. the end-to-end QoS requirements for the traffic transmission between the remote UE and the UPF. In some embodiments, the PC5 QoS parameters can include PQI, and conditionally other parameters such as MFBR/GFBR, etc.

If the end-to-end QoS requirements can be supported by the mapping entries in the QoS mapping, the relay UE can use the 5QI of the mapping entry for the Uu QoS control, and the relay UE can use the PQI of the mapping entry for the PC5 QoS control. If the end-to-end QoS requirements cannot be supported by any mapping entry in the QoS mapping, the relay UE determines the 5QI for the Uu QoS control and the PQI for the PC5 QoS control based on its implementation. The relay UE provides the QoS information (Info, which can, for example, include the PQI value selected by the relay UE) to the remote UE as part of the accept message.

However, when establishing the end-to-end QoS between the remote UE and the UPF, an issue is ignored, namely that the capability of the relay UE will be limited when a large number of remote UE are connected via the same relay UE for relaying, for example, the data transmission rate will be limited, etc. How to manage the QoS flows of the large number of remote UE after relaying when the relay UE has limited capacity has become an urgent problem.

Embodiments of the present disclosure provide a relay communication method, in which a relay terminal performs a capability detection and provides relay services for multiple remote terminals based on a capability detection result, thereby achieving fair and effective QoS sharing among remote terminals accessing the network via the same relay terminal.

FIG. 3 is a flowchart of a relay communication method according to one or more embodiments of the present disclosure. As shown in FIG. 3, the relay communication method can be applied in a relay terminal, such as the relay UE in FIGS. 1 and 2. The method can include the following steps.

In step S11, in response to receiving relay service requests sent by multiple remote terminals, a Quality of Service (QoS) capability detection is performed on the relay terminal.

In some embodiments, when remote UE needs to access the network but there is no network coverage around it, the remote UE can discover a relay and establish a connection with the relay to achieve the network access. Therefore, the remote UE can perform a relay discovery procedure to find the relay UE, and establish a connection to the relay UE.

When the relay UE is selected simultaneously by multiple remote UEs for providing network connections, the relay UE can perform the QoS capability detection to determine whether it can meet the QoS requirements from the multiple remote UEs.

In step S12, based on a capability detection result, a relay access to the network is performed for the multiple remote terminals.

In some embodiments, the relay UE can perform corresponding relay access to the network for the multiple remote UEs based on the QoS capability detection result in step S11, to enable the remote UEs to access the network.

According to embodiments of the present disclosure, the relay terminal can perform the capability detection and provide relay services to multiple remote terminals based on the capability detection result, thereby achieving fair and effective QoS sharing among the remote terminals accessing the network via the same relay.

FIG. 4 is a flowchart of a relay communication method according to one or more embodiments of the present disclosure. As shown in FIG. 4, in the relay communication method, that performing, based on the capability detection result, the relay access to the network for the multiple remote terminals can include the following steps.

In step S21, in response to the capability detection result indicating that a QoS capability is not sufficient to provide relay services for the multiple remote terminals simultaneously, limited resource indication information is sent to at least one remote terminal among the multiple remote terminals. The limited resource indication information is configured to indicate to the remote terminal to adjust a relay access network policy.

In some embodiments, if the relay UE is unable to provide relay services to multiple remote UEs simultaneously due to the capability limitation, the relay UE can send the limited resource indication information to at least one remote UE among the multiple remote UEs. The limited resource indication information can be configured to indicate to respective remote UE to adjust the relay access network policy.

In the communication method provided by embodiments of the present disclosure, sending the limited resource indication information to at least one remote terminal among the multiple remote terminals can include: sending, based on a priority level corresponding to each remote terminal among the multiple remote terminals, the limited resource indication information to at least one remote terminal whose priority level satisfies a preset condition.

In some embodiments, different remote UEs can be pre-configured with different priority levels. According to the pre-configured preset condition, the limited resource indication information can be sent to at least one remote UE whose priority level satisfies the preset condition. In some embodiments, the pre-configured priority level can also refer to the priority level in PQI of the PC5 QoS information, and use the priority level in PQI as the priority level of respective remote UE.

In some embodiments, the preset condition can be a pre-configured priority threshold, and the relay UE can send the limited resource indication information to at least one remote UE having a priority level lower than the priority threshold. In some embodiments, the preset condition can be sending the limited resource indication information to at least one remote UE having a lower priority level. In some embodiments, the limited resource indication information is sent to the remote UE having the lowest priority level. Alternatively, in some embodiments, the multiple remote UEs can be sorted based on their priority levels from high to low or from low to high, and the limited resource indication information can be sent to X remote UEs having the lowest priority level based on the sorting result. It can be understood that X is a positive integer, and the value of X can be set arbitrarily according to actual situations, which is not limited by the present disclosure.

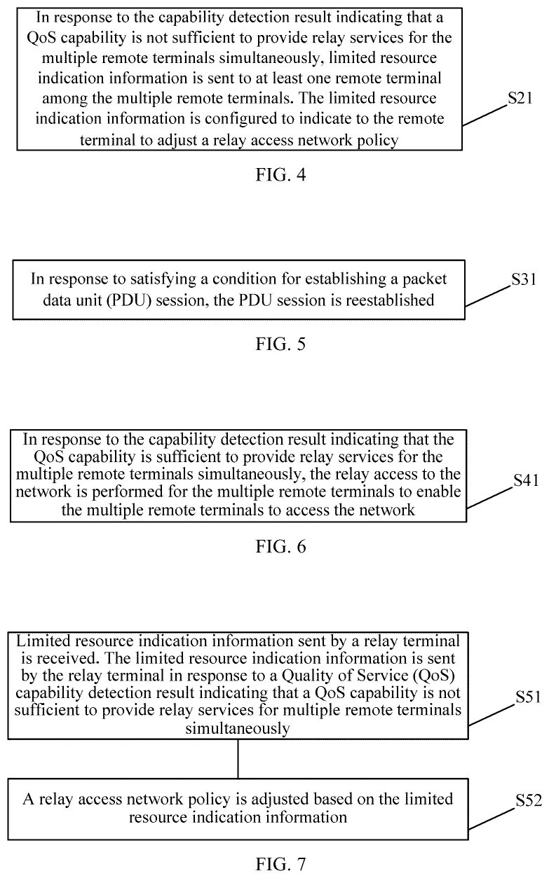

FIG. 5 is a flowchart of a relay communication method according to one or more embodiments of the present disclosure. As shown in FIG. 5, the relay communication method can further include the following steps.

In step S31, in response to satisfying a condition for establishing a packet data unit (PDU) session, the PDU session is reestablished.

In some embodiments, if the relay UE can support the condition for establishing the PDU session for the remote UE, the relay UE can reestablish the PDU session for respective remote UE.

In the communication method provided by embodiments of the present disclosure, satisfying the condition for establishing the PDU session includes at least one of the following: the packet data unit (PDU) session(s) already established by the relay terminal is/are not sufficient to enable the multiple remote terminals to access the network, or the indication information configured to indicate to establish a new PDU session is received.

In some embodiments, the relay UE can have established the PDU session(s) in advance, and when the pre-established PDU session(s) cannot meet the requirements from the multiple remote UEs to access the network simultaneously, a PDU session can be reestablished for the remote UE whose requirement is not satisfied to access the network. In some embodiments, if the relay UE has not established the PDU session in advance, the relay service requests from current multiple remote UEs can include indication information configured to indicate to establish a new PDU session. The relay UE can reestablish the PDU sessions for the current multiple remote UEs based on the indication information configured to indicate to establish the new PDU session.

In some embodiments, if the relay UE sends the limited resource indication information to some remote UEs, the relay UE can continue to perform corresponding relay access to the network for the remote UE(s) to which the limited resource indication information is not sent among the multiple remote UEs. In some embodiments, the relay UE can establish the new PDU session(s) for the remote UE(s) to which the limited resource indication information is not sent.

FIG. 6 is a flowchart of a relay communication method according to one or more embodiments of the present disclosure. As shown in FIG. 6, in the relay communication method, that performing, based on the capability detection result, the relay access to the network for the multiple remote terminals can include the following steps.

In step S41, in response to the capability detection result indicating that the QoS capability is sufficient to provide relay services for the multiple remote terminals simultaneously, the relay access to the network is performed for the multiple remote terminals to enable the multiple remote terminals to access the network.

In some embodiments, if the capability of the relay UE can satisfy all relay services for the multiple remote UEs, that is, satisfy the QoS required by the multiple remote UEs, the relay UE can perform corresponding relay access to the network for the multiple remote UEs to enable the multiple remote UEs to access the network.

In some embodiments, the relay UE can have established the PDU sessions in advance and uses the pre-established PDU sessions to perform the relay access to the network for the multiple remote UEs. In some embodiments, the relay UE can also establish new PDU sessions for the multiple remote UEs to perform the relay access to the network for the multiple remote UEs.

According to embodiments of the present disclosure, the relay UE can perform the capability detection and provide relay services to multiple remote UEs based on the capability detection result, thereby achieving fair and effective QoS sharing among the remote UEs accessing the network via the same relay.

FIG. 7 is a flowchart of a relay communication method according to one or more embodiments of the present disclosure. As shown in FIG. 7, the relay communication method can be applied in a remote terminal, such as the remote UE in FIGS. 1 and 2. The method can include the following steps.

In step S51, limited resource indication information sent by a relay terminal is received. The limited resource indication information is sent by the relay terminal in response to a Quality of Service (QoS) capability detection result indicating that a QoS capability is not sufficient to provide relay services for multiple remote terminals simultaneously.

In some embodiments, the remote UE can receive the limited resource indication information sent by the relay UE. The limited resource indication information is sent by the relay UE based on the QoS capability detection result when the QoS capability detection result indicates that the QoS capability is not sufficient to provide relay services for the multiple remote UEs simultaneously.

In some embodiments, it can be understood that the remote UE receiving the limited resource indication information sent by the relay UE can be the remote UE whose priority level satisfies the preset condition, for example, the remote UE having a lower priority level. In some embodiments, the remote UE can be pre-configured with a corresponding priority level. The preset condition can be that a priority threshold is pre-configured, and the remote UE that receives the limited resource indication information sent by the relay UE can be the remote UE having a priority level lower than the priority threshold. In some embodiments, the preset condition can be one of the following: the preset condition can be the remote UE determined by the relay UE side, which has the lowest priority level among the multiple remote UEs, alternatively, the preset condition can be X remote UEs determined by the relay UE side, which have the lowest priority levels among the multiple remote UEs.

In step S52, a relay access network policy is adjusted based on the limited resource indication information.

In some embodiments, the remote UE can adjust its relay access network policy based on the limited resource indication information received.

In the communication method provided by embodiments of the present disclosure, adjusting the relay access network policy can include: in response to the remote terminal supporting multiple QoS levels, adjusting a QoS level of the remote terminal.

In some embodiments, the remote UE can be configured with multiple QoS levels. When the remote UE receives the limited resource indication information sent by the relay UE, meaning that the QoS requirements from the remote UE cannot be satisfied by the relay UE, and thus the remote UE can adjust the QoS level, such as lowering the QoS level. As a result, the QoS requirements are lowered, so that it is convenience for the relay UE to meet the QoS requirements from the remote UE and complete the relay access to the network for the remote UE.

In some embodiments, the QoS level can be divided into multiple levels according to actual situations. For example, the QoS level can include three levels. A first level is the highest level, meaning that the QoS must have the set parameters to be strictly satisfied. A second level is a level at which QoS does not need to have the set parameters to be strictly satisfied, but still requires certain conditions to be satisfied (i.e. lowering the minimum thresholds for various QoS parameters). A third level is a level at which QoS does not need to have the set parameters to be strictly satisfied, as long as it can complete the relay access to the network and establish a PDU session with UPF. It can be understood that the above descriptions are only examples, describing some possible embodiments, but do not impose any limitation on the present disclosure.

In the communication method provided by embodiments of the present disclosure, adjusting the relay access network policy can include adjusting the relay terminal that the remote terminal is to access.

It can be understood that when the remote UE receives the limited resource indication information sent by the relay UE, it means that the relay UE cannot meet the QoS requirements from the remote UE. Therefore, the remote UE can adjust the relay UE that the remote UE is to access. That is, the remote UE can select other relay UEs that may meet the QoS requirements from the remote UE to access the network.

It should be understood that part of the executive modes of the remote UE and the relay UE are similar. Therefore, the descriptions can refer to the corresponding parts for the network device, which will not be repeated in the present disclosure.

According to the present disclosure, the relay access network policy can be adjusted based on the limited resource indication information sent by the relay terminal after the capability detection, thereby achieving fair and effective QoS sharing among the remote terminals accessing the network via the same relay.

FIG. 8 is a schematic diagram of a relay communication signaling process according to one or more embodiments of the present disclosure. As shown in FIG. 8, the relay communication signaling process can include the following steps.

In step S61, the relay UE is authorized to serve as a relay and the provisioning is performed for the relay UE.

In step S62, the remote UE is authorized to be allowed to access the relay and the provisioning is performed for the remote UE.

It can be understood that both S61 and S62 are steps for initial configurations, and there is no strict execution order between them. S61 and S62 only indicate that the initial configured authorization and the provisioning performed for the remote UE and the relay UE in advance are required.

In step S63, a PDU session is established between the relay UE and the UPF.

In some embodiments, S63 is an optional step, which, in some cases, indicates that the relay UE can establish the PDU session with the UPF in advance, so that the relay UE can use the PDU session later when performing the relay access for the remote UE.

It can be understood that the relay UE can establish a PDU session for any relay service node it supports before establishing a connection with the remote UE.

In step S64, the remote UE performs a relay discovery procedure.

It can be understood that in S64, the remote UE needs to access the network at the moment, but there is no network coverage around the remote UE. The remote UE can perform the relay discovery procedure to discover the relay UEs. As part of the discovery procedure, the remote UE can obtain information about the connectivity service provided by the relay UEs.

In step S65, the remote UE sends a relay service request to the relay UE and attempts to establish a connection.

In some embodiments, the remote UE selects the relay UEs discovered in S64 and attempts to establish a connection for unicast mode communication. For example, the remote UE can provide PC5 QoS information (Info) to the relay UE during the connection establishment, as described in clause 6.4.3.6 of TS 23.304. In some cases, the remote UE can also provide PC5 QoS rules to the relay UE.

In step S66, the relay UE performs a QoS capability detection.

When multiple remote UEs select the same relay UE, the relay UE can detect, based on the QoS requirements from each remote UE, whether it has the capability to provide relay services for these remote UEs simultaneously.

It can be understood that the capability limitation may be caused by the hardware deployment of the relay UE. For the IP PDU session type and IP traffic over a PC5 reference point, the relay UE needs to allocate an IPV6 prefix or IPV4 address for the remote UE.

In step S67, the relay UE sends limited resource indication information to at least one remote UE.

In some embodiments, if the relay UE is unable to provide connections for these remote UEs due to the capability limitation, the relay UE will send the limited resource indication information to the remote UE having a lower priority level.

In step S68, the remote UE adjusts a relay access network policy based on the limited resource indication information.

In some embodiments, if the remote UE supports multiple QoS levels, the remote UE receiving the limited resource indication information can reselect the relay UE or adjust the QoS level.

In step S69, the relay UE reestablishes a PDU session.

In some embodiments, if S63 is not executed, that is, there is no PDU sessions associated with the relay UE, or the PDU session(s) in S63 does not meet the requirements from current multiple remote UEs, or a new PDU session is needed for the relay access to the network, the relay UE can initiate a new PDU session establishment procedure to the UPF before the PC5 connection establishment with the remote UE is completed, to establish a new PDU session for corresponding relay access to the network.

It can be understood that after adjusting the relay access network policy, the remote UE can resend the relay service request to the relay UE and execute the above S65 again.

In step S70, the relay UE allocates an IP address/prefix for the remote UE.

In some embodiments, reference can be made to clause 5.5.1.3 of TS 23.304, for the IP PDU session type and the IP traffic over the PC5 reference point, the IPV6 prefix or the IPV4 address is allocated for the remote UE at Layer-3. It can be understood that Layer-3 is the network layer.

In some embodiments, the remote UE can request to the relay UE to modify the QoS, therefore, the relay communication signaling process can also include the following steps.

In step S71, the remote UE sends Layer-2 link modification indication information to the relay UE.

In some embodiments, the remote UE can provide new PC5 QoS rules to the relay UE using the Layer-2 link modification procedure, as specified in clause 6.4.3.4 of TS 23.304, which is not limited by the present disclosure. It can be understood that Layer-2 is the data link layer.

In step S72, the relay UE adjusts the PDU session based on the link modification indication information.

In some embodiments, the relay UE can generate a packet filter for use on the Uu interface based on the received PC5 QoS rules, and can perform the PDU session modification requested by the remote UE to establish a new QoS flow or bind the traffic to an existing QoS flow.

In step S73, the relay UE sends a Remote UE report associated with the multiple remote UEs to the SMF.

In some embodiments, the Remote UE report can include identity documents (ID) of the remote user, remote UE information (Info), and other information, for use in the PDU sessions related to the relay access to the network. In some embodiments, the Remote User ID is the identity of the remote UE user (provided via User Info) that has been successfully connected, and the remote UE information (Info) is used to assist in identifying the remote UE in 5GC.

The SMF can store the Remote User ID and the related remote UE information in the SM context of the relay UE for this PDU session associated with the relay.

In some embodiments, after the above steps have been partially or all executed, the relay UE can perform corresponding relay access to the network for the remote UE.

According to the present disclosure, the relay terminal performs the capability detection and provides relay services to multiple remote UEs based on the capability detection result, thereby achieving fair and effective QoS sharing among the remote terminals accessing the network via the same relay.

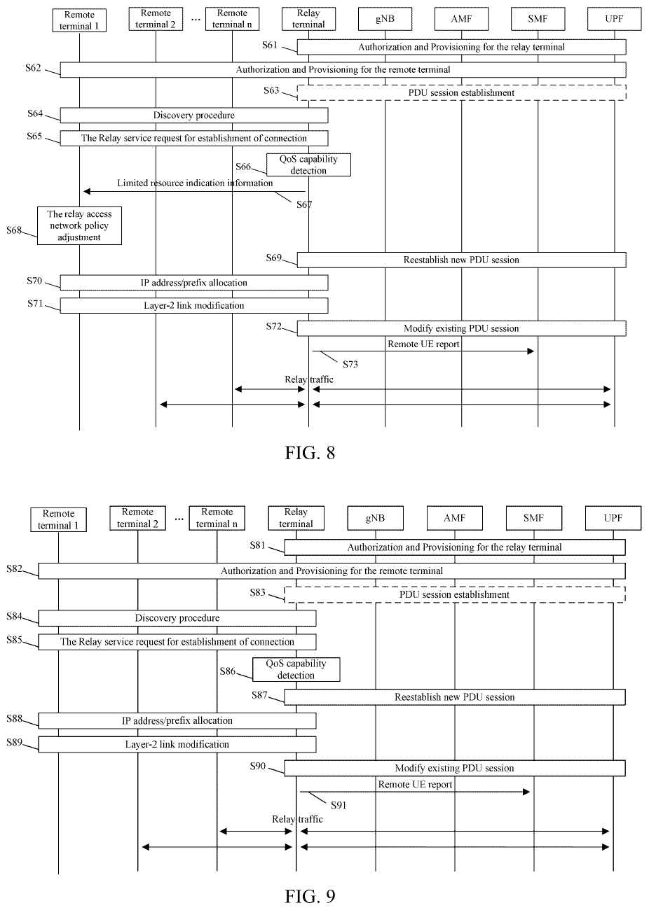

FIG. 9 is a schematic diagram of a relay communication signaling process according to one or more embodiments of the present disclosure. As shown in FIG. 9, the relay communication signaling process can include the following steps.

In step S81, the relay UE is authorized to serve as a relay and the provisioning is performed for the relay UE.

In step S82, the remote UE is authorized to be allowed to access the relay and the provisioning is performed for the remote UE.

In step S83, a PDU session is established between the relay UE and the UPF.

In step S84, the remote UE performs a relay discovery procedure.

In step S85, the remote UE sends a relay service request to the relay UE and attempts to establish a connection.

In step S86, the relay UE performs a QoS capability detection.

It can be understood that the execution processes of S81 to S86 are similar to the execution processes of S61 to S66, and specific details can be referred to the corresponding descriptions in FIG. 8, which will not be repeated in the present disclosure.

In step S87, the relay UE reestablishes a PDU session.

In some embodiments, if the capability of the relay UE can provide connections for these remote UEs, the PDU sessions established in S83 can be directly used. In some embodiments, if S83 is not executed, or if the PDU sessions in S83 do not meet the requirements from current multiple remote UEs, or if a new PDU session is needed for the relay access to the network, the relay UE can initiate a new PDU session establishment procedure to the UPF before the PC5 connection establishment with the remote UE is completed, to establish a new PDU session for corresponding relay access to the network.

In step S88, the relay UE allocates an IP address/prefix for the remote UE.

In step S89, the remote UE sends Layer-2 link modification indication information to the relay UE.

In step S90, the relay UE adjusts the PDU session based on the link modification indication information.

In step S91, the relay UE sends a Remote UE report associated with the multiple remote UEs to the SMF.

It can be understood that the execution processes of S88 to S91 are similar to the execution processes of S70 to S73, and specific details can be referred to the corresponding descriptions in FIG. 8, which will not be repeated in the present disclosure.

According to the present disclosure, the relay terminal performs the capability detection and provides relay services to multiple remote terminals based on the capability detection result, thereby achieving fair and effective QoS sharing among the remote terminals accessing the network via the same relay.

It should be noted that those skilled in the art can understand that various embodiments/implementations mentioned in the present disclosure can be implemented in conjunction with or independent of the aforementioned embodiments. Whether implemented alone or in conjunction with the aforementioned embodiments, the implementation principles are similar. In the present disclosure, some embodiments are described as being implemented together. Those skilled in the art can understand that these descriptions do not limit embodiments of the present disclosure.

Embodiments of the present disclosure also provide a relay communication apparatus based on the same concept.

It can be understood that the relay communication apparatus provided by embodiments of the present disclosure includes hardware structures and/or software modules corresponding to each function to achieve the above functions. Based on the units and algorithm steps of the examples disclosed in the embodiments, the present disclosure can be implemented in the form of hardware or a combination of hardware and computer software. Whether a certain function is implemented through hardware or computer software driven the hardware depends on the specific applications and design constraints of technical solutions. Those skilled in the art can use different methods to achieve the described functions for each specific application, but such implementation should not be considered beyond the scope of the technical solutions disclosed in embodiments of the present disclosure.

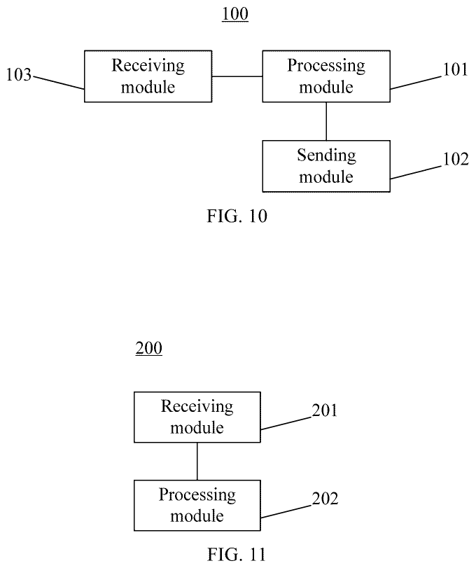

FIG. 10 is a schematic diagram of a relay communication apparatus according to one or more embodiments of the present disclosure. As shown in FIG. 10, the apparatus 100 can be a relay terminal, also known as relay UE. The apparatus 100 can include a processing module 101, which is configured to perform, in response to receiving relay service requests sent by multiple remote terminals, a Quality of Service (QoS) capability detection on the relay terminal. The processing module 101 is further configured to perform, based on a capability detection result, a relay access to the network for the multiple remote terminals to access a network.

According to the present disclosure, the relay terminal performs the capability detection and provides relay services to multiple remote terminals based on the capability detection result, thereby achieving fair and effective QoS sharing among the remote terminals accessing the network via the same relay.

In some embodiments, the apparatus 100 further includes a sending module 102 configured to send, in response to the capability detection result indicating that a QoS capability is not sufficient to provide relay services for the multiple remote terminals simultaneously, limited resource indication information to at least one remote terminal among the multiple remote terminals. The limited resource indication information is configured to indicate to the remote terminal to adjust a relay access network policy.

According to the present disclosure, the limited resource indication information can indicate to the remote UE to adjust the corresponding relay access network policy, thereby achieving fair and effective QoS sharing among the remote terminals accessing the network via the same relay.

In some embodiments, the sending module 102 is further configured to send, based on a priority level corresponding to each remote terminal among the multiple remote terminals, the limited resource indication information to at least one remote terminal whose priority level satisfies a preset condition.

According to the present disclosure, the limited resource indication information is sent to the at least one remote UE whose priority level satisfies the preset condition, thereby ensuring that the relay UE can provide the relay services is in priority to the important remote UE.

In some embodiments, processing module 101 is further configured to reestablish the PDU session in response to satisfying a condition for establishing a packet data unit (PDU) session.

In some embodiments, the apparatus 100 further includes a receiving module 103. Satisfying the condition for establishing the PDU session includes at least one of the following: the packet data unit (PDU) session already established by the relay terminal is not sufficient to enable the multiple remote terminals to access the network, or the receiving module 103 receives indication information configured to indicate to establish a new PDU session.

In some embodiments, the processing module 101 is further configured to perform, in response to the capability detection result indicating that a QoS capability is sufficient to provide relay services for the multiple remote terminals simultaneously, the relay access to the network for the multiple remote terminals to enable the multiple remote terminals to access the network.

Specific ways in which each module of the apparatus 100 in the above embodiments performs operations have been described in detail in the relevant method embodiments, and will not be elaborated here.

FIG. 11 is a schematic diagram of a relay communication apparatus according to one or more embodiments of the present disclosure. As shown in FIG. 11, the apparatus 200 can be a remote terminal, also known as remote UE. The apparatus 200 can include a receiving module 201 and a processing module 202. The receiving module 201 is configured to receive limited resource indication information sent by a relay terminal. The limited resource indication information is sent by the relay terminal in response to a Quality of Service (QoS) capability detection result indicating that a QoS capability is not sufficient to provide relay services for multiple remote terminals simultaneously. The processing module 202 is configured to adjust, based on the limited resource indication information, a relay access network policy.

According to the present disclosure, the relay access network policy is adjusted based on the limited resource indication information sent by the relay terminal after the capability detection, thereby achieving fair and effective QoS sharing among the remote terminals accessing the network via the same relay.

In some embodiments, the processing module 202 is further configured to adjust a QoS level of the remote terminal in response to the remote terminal supporting multiple QoS levels.

According to the present disclosure, the remote UE adjusts the corresponding QoS level, thereby achieving fair and effective QoS sharing among the remote terminals accessing the network via the same relay.

In some embodiments, the processing module 202 is further configured to adjust the relay terminal that the remote terminal is to access.

According to the present disclosure, the remote UE adjusts the relay UE it is to access, thereby achieving fair and effective QoS sharing among the remote terminals accessing the network via the same relay.

Specific ways in which each module of the apparatus 200 in the above embodiments performs operations have been described in detail in the relevant method embodiments, and will not be elaborated here.

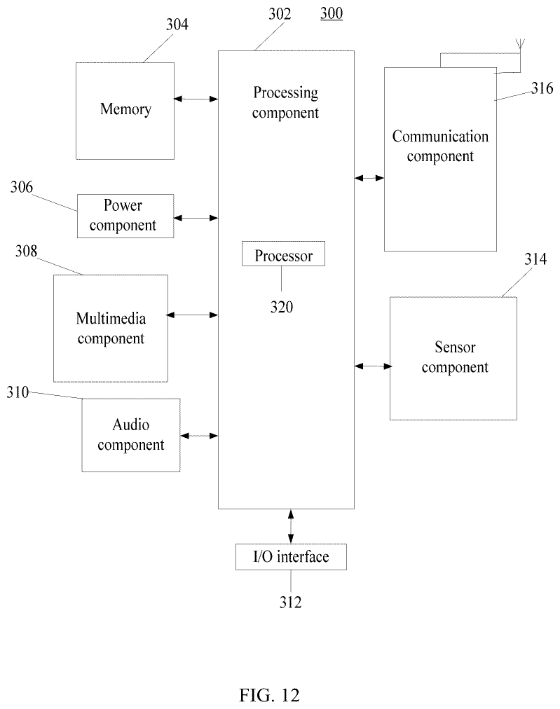

FIG. 12 is a schematic diagram of a relay communication device 300 according to one or more embodiments of the present disclosure. In some embodiments, the device 300 can be provided as a relay UE or a remote UE. As shown in FIG. 12, the device 300 can be a mobile phone, a computer, a digital broadcasting user device, a messaging device, a game console, a tablet device, a medical device, a fitness device, a personal digital assistant, a RedCap terminal, and other devices.

As shown in FIG. 12, the device 300 can include one or more of the following components: a processing component 302, a memory 304, a power component 306, a multimedia component 308, an audio component 310, an input/output (I/O) interface 312, a sensor component 314, and a communication component 316.

The processing component 302 typically controls the overall operation of the device 300, such as operations associated with display, telephone call, data communication, camera operation, and recording operations. The processing component 302 may include one or more processors to execute instructions to complete all or part of the methods described above. In addition, the processing component 302 may include one or more modules to facilitate interactions between the processing component 302 and other components. For example, the processing component 302 may include a multimedia module to facilitate interaction between the multimedia component 308 and the processing component 302.

The memory 304 is configured to store various types of data to support operations in the device 300. Examples of such data include instructions, contact data, phone book data, messages, pictures, videos, and the like for any application or method operating on the device 300. The memory 304 can be implemented by any type of volatile or non-volatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk.

The power component 306 provides power for various components of the device 300. The power component 306 may include a power management system, one or more power supplies, and other components associated with generating, managing, and distributing power for the device 300.

The multimedia component 308 includes a display screen providing an output interface between the device 300 and the user. In some embodiments, the screen may include a liquid crystal display (LCD) and a touch panel (TP). If the screen includes a touch panel, the screen can be implemented as a touch screen to receive input signals from the user. The touch panel includes one or more touch sensors to sense touch, sliding, and gestures on the touch panel. The touch sensor can not only sense the boundaries of touch or sliding actions, but also detect the duration and pressure related to the touch or sliding operation. In some embodiments, the multimedia component 308 includes a front camera and/or a rear camera. When the device 300 is in operation mode, such as shooting mode or video mode, the front camera and/or rear camera can receive external multimedia data. Each front camera and rear camera can be a fixed optical lens system or have focal length and optical zoom capability.

The audio component 310 is configured to output and/or input audio signals. For example, the audio component 310 includes a microphone (MIC), which is configured to receive an external audio signal when the device 300 is in an operation mode, such as a calling mode, a recording mode, and a voice recognition mode. The received audio signal may be further stored in memory 304 or transmitted via communication component 316. In some embodiments, the audio component 310 also includes a speaker for outputting audio signals.

The I/O interface 312 provides an interface between the processing component 302 and peripheral interface modules, which can be a keyboard, click wheel, button, etc. These buttons may include, but are not limited to, the Home button, Volume button, Start button, and Lock button.

The sensor component 314 includes one or more sensors for providing various aspects of condition evaluation for the device 300. For example, the sensor component 314 can detect an open/closed state of the device 300, relative positioning of the components. The component is, for example, a display and a keypad of the device 300. The sensor component 314 can also detect changes in the position of the device 300 or one component of the device 300, presence or absence of the user's contact with the device 300, orientation or acceleration/deceleration of the device 300 and temperature change of the device 300. The sensor component 314 may include a proximity sensor configured to detect the presence of nearby objects without any physical contact. The sensor component 314 may also include a light sensor, such as a CMOS or CCD image sensor, for use in imaging applications. In some embodiments, the sensor component 314 may also include an acceleration sensor, a gyroscope sensor, a magnetic sensor, a pressure sensor, or a temperature sensor.

The communication component 316 is configured to facilitate wired or wireless communication between the device 300 and other devices. The device 300 can access wireless networks based on communication standards, such as WiFi, 2G or 3G, or a combination thereof. In some embodiments, the communication component 316 receives a broadcast signal or broadcast related information from an external broadcast management system via a broadcast channel. In some embodiments, the communication component 316 also includes a near field communication (NFC) module to facilitate short range communication. For example, the NFC module can be implemented based on radio frequency identification (RFID) technology, infrared data association (IrDA) technology, ultra wideband (UWB) technology, Bluetooth (BT) technology and other technologies.

In some embodiments, the device 300 can be implemented through one or more application specific integrated circuits (ASIC), digital signal processors (DSP), digital signal processing devices (DSPD), programmable logic devices (PLD), field programmable gate arrays (FPGA), controllers, microcontrollers, microprocessors, or other electronic components, for implementing above methods.

In some embodiments, a non-transitory computer-readable storage medium including instructions is also provided, such as a memory 304 including instructions, which can be executed by a processor of the device 300 to complete above methods. For example, the non-transitory computer-readable storage medium can be ROM, random access memory (RAM), CD-ROM, tapes, floppy disks, optical data storage devices, etc.

According to the present disclosure, the relay UE will perform the capability detection when it is selected by multiple remote UEs. When identifying the multiple remote UEs can't be served by the relay UE simultaneously due to capability limitation, the relay UE will send a limited resource indication to the remote UE having a lower QoS priority. The remote UE will reselect the relay UE or lower the QoS level if multiple QoS levels are supported. As a result, it is possible to achieve fair and effective QoS sharing among the remote terminals accessing the network via the same relay.

It can be further understood that “multiple” in the present disclosure refers to two or more, and other quantifiers are similar to this. The term such as “and/or” describes the association relationship between related objects, indicating the presence of three types of relationships. For example, A and/or B can represent: A exists alone, A and B exist simultaneously, and B exists alone. The character “/” generally indicates that the related objects before and after the character is in an “or” relationship. The singular forms of “one”, “the”, and “a” are also intended to include the majority forms, unless the context clearly indicates otherwise.

It can be further understood that the terms such as “first”, “second”, etc. are used to describe various information, but these information should not be limited to these terms. These terms are only used to distinguish information of the same type from each other and do not indicate a specific order or an important degree. In fact, expressions such as “first”, “second”, etc. can be used interchangeably. For example, without departing from the scope of the present disclosure, the first information can also be referred to as the second information, and similarly, the second information can also be referred to as the first information.

It can be further understood that although the operations are described in a specific order in the drawings in embodiments of the present disclosure, it should not be understood as requiring the execution of these operations in the specific order or in serial sequence shown, or requiring the execution of all the operations shown to achieve the desired results. In specific environments, multitasking and parallel processing may be advantageous.

After considering the specification and practices of the invention disclosed herein, those skilled in the art will easily come up with other implementation solutions of the present disclosure. The present disclosure aims to cover any variations, uses, or adaptive changes of the present disclosure, which follow the general principles of the present disclosure and include common knowledge or commonly used technical means in the art that are not disclosed in the present disclosure.

It should be understood that embodiments of the present disclosure are not limited to the precise structure described above and shown in the drawings, and various modifications and changes can be made without departing from its scope. The scope of the present disclosure is limited only by the appended claims.

1. A relay communication method, performed by a relay terminal, the method comprising:
performing, in response to receiving relay service requests sent by multiple remote terminals, a Quality of Service (QoS) capability detection on the relay terminal; and
performing, based on a capability detection result, a relay access to the network for the multiple remote terminals.

2. The method according to claim 1, wherein performing, based on the capability detection result, the relay access to the network for the multiple remote terminals, comprises:
sending, in response to the capability detection result indicating that a QoS capability is not sufficient to provide relay services for the multiple remote terminals simultaneously, limited resource indication information to at least one remote terminal among the multiple remote terminals, wherein the limited resource indication information is configured to indicate to the remote terminal to adjust a relay access network policy.

3. The method according to claim 2, wherein sending the limited resource indication information to the at least one remote terminal among the multiple remote terminals, comprises:
sending, based on a priority level corresponding to each remote terminal among the multiple remote terminals, the limited resource indication information to at least one remote terminal whose priority level satisfies a preset condition.

4. The method according to claim 1, further comprising:
reestablishing, in response to satisfying a condition for establishing a packet data unit (PDU) session, the PDU session.

5. The method according to claim 4, wherein satisfying the condition for establishing the PDU session, comprises at least one of:
a PDU session already established by the relay terminal being not sufficient to enable the multiple remote terminals to access the network; or
indication information configured to indicate to establish a new PDU session being received.

6. The method according to claim 1, wherein performing, based on the capability detection result, the relay access to the network for the multiple remote terminals, comprises:
performing, in response to the capability detection result indicating that a QoS capability is sufficient to provide relay services for the multiple remote terminals simultaneously, the relay access to the network for the multiple remote terminals.

7. A relay communication method, performed by a remote terminal, the method comprising:
receiving limited resource indication information sent by a relay terminal, wherein the limited resource indication information is sent by the relay terminal in response to a Quality of Service (QoS) capability detection result indicating that a QoS capability is not sufficient to provide relay services for multiple remote terminals simultaneously; and
adjusting, based on the limited resource indication information, a relay access network policy.

8. The method according to claim 7, wherein adjusting the relay access network policy comprises:
adjusting, in response to the remote terminal supporting multiple QoS levels, a QoS level of the remote terminal.

9. The method according to claim 7, wherein adjusting the relay access network policy comprises:
adjusting the relay terminal that the remote terminal is to access.

10.-11. (canceled)

12. A relay terminal comprising:
a processor; and
a memory configured to store instructions executable by the processor;
wherein the processor is configured to:
perform, in response to receiving relay service requests sent by multiple remote terminals, a Quality of Service (QoS) capability detection on the relay terminal; and
perform, based on a capability detection result, a relay access to the network for the multiple remote terminals.

13. (canceled)

14. The relay terminal according to claim 12, wherein the processor is further configured to:
send, in response to the capability detection result indicating that a QoS capability is not sufficient to provide relay services for the multiple remote terminals simultaneously, limited resource indication information to at least one remote terminal among the multiple remote terminals, wherein the limited resource indication information is configured to indicate to the remote terminal to adjust a relay access network policy.

15. The relay terminal according to claim 14, wherein the processor is further configured to:
send, based on a priority level corresponding to each remote terminal among the multiple remote terminals, the limited resource indication information to at least one remote terminal whose priority level satisfies a preset condition.

16. The relay terminal according to claim 12, wherein the processor is further configured to:
reestablish, in response to satisfying a condition for establishing a packet data unit (PDU) session, the PDU session.

17. The relay terminal according to claim 16, wherein satisfying the condition for establishing the PDU session, comprises at least one of:
a PDU session already established by the relay terminal being not sufficient to enable the multiple remote terminals to access the network; or
indication information configured to indicate to establish a new PDU session being received.

18. The relay terminal according to claim 12, wherein the processor is further configured to:
perform, in response to the capability detection result indicating that a QoS capability is sufficient to provide relay services for the multiple remote terminals simultaneously, the relay access to the network for the multiple remote terminals.

19. A remote terminal, comprising:
a processor; and
a memory configured to store instructions executable by the processor;
wherein the processor is configured to:
receive limited resource indication information sent by a relay terminal, wherein the limited resource indication information is sent by the relay terminal in response to a Quality of Service (QoS) capability detection result indicating that a QoS capability is not sufficient to provide relay services for multiple remote terminals simultaneously; and
adjust, based on the limited resource indication information, a relay access network policy.

20. The remote terminal according to claim 19, wherein the processor is further configured to:
adjust, in response to the remote terminal supporting multiple QoS levels, a QoS level of the remote terminal.

21. The remote terminal according to claim 19, wherein the processor is further configured to:
adjust the relay terminal that the remote terminal is to access.
